(19) United States
(12) Patent Application Publication
(10) Pub. No.: US 2005/0138642 A1
(43) Pub. Date: Jun. 23, 2005

(54) Event correlation system and method for monitoring resources

(75) Inventors: Jochen Breh, Stuttgart (DE); Gerd Breiter, Wildberg (DE); Juergen Schneider, Althengstett (DE); Thomas Spatzier, Sindelfingen (DE); Jeffrey A. Frey, New Paltz, NY (US)

Correspondence Address: Eugene I. Shkurko;IBM Corporation - MS P386, 2455 South Road, Poughkeepsie, NY, 12601, US

(73) Assignee: International Business Machines Corporation, Armonk, NY (US)

(21) Appl. No.: 11/016,622

(22) Filed: Dec. 17, 2004

(30) Foreign Application Priority Data
Dec. 18, 2003 (DE) 03104798.8

(51) Int. Cl. G06F 9/46

(52) U.S. Cl. 719/318

(57) ABSTRACT

An Event Correlation System and method for monitoring resources that send low-level events which are filtered and aggregated in accordance with event filtering and aggregation rules to detect high-level events. The resources are monitored by a General Event Service Application that can be used by any client application to perform event filtering and aggregation.

### CROSS REFERENCE TO RELATED APPLICATIONS

U.S. patent application DE920030084US1, entitled “Resource Management” filed concurrently herewith is assigned to the same assignee hereof and contains subject matter related, in certain respect, to the subject matter of the present application. The above-identified patent application is incorporated herein by reference.

### FIELD OF THE PRESENT INVENTION

The present invention relates to an Event Correlation System and method for monitoring resources that send low-level events which are filtered and aggregated in accordance with event filtering and aggregation rules to detect high-level events.

1. Background of the Present Invention

An event is an undirected message that informs about a change in a system's state, i.e. a change of one of the system's Service Data Elements. Service Data Elements are attributes (name-value pairs) that define a system's state. One Service Data Element is a single attribute (name-value pair) out of a system's Service Data. A low-level event is a primitive event sent by a resource, usually carrying very little, primitive information (e.g. information about change of a single Service Data Element). A higher-level event can be detected among low-level events using filtering rules. Higher-level events can contain information about the change of a combination of several Service Data Elements. Filtering rules describe how higher-level events can be detected from low-level events.

2. State of the Art

In prior art Event Correlation Systems and methods, users can define filtering and aggregation rules which describe those high-level events they are interested in. For example it is possible to describe a composite event “E” that shall exist, if a resource's CPU-utilization is above 90% and its free working memory is below 5%. Furthermore, users can define aggregate events or event patterns based on previously defined composite events. For instance it is possible to define a pattern “P” that shall be detected if the composite event “E” occurred more than ten times within one minute.

All user-defined rules are stored in a Rules Base. If primitive events sent by resources are received, an event detection and filtering component analyses all filtering rules contained in the Rules Base and tries to detect composite events. Subsequently, an event aggregation and pattern detection component uses user-defined rules to aggregate recognized composite events and to detect aggregate events/event-patterns. All detected higher-level events (composite events as well as aggregate events/event-patterns) are reported to several consumers, such as event monitors, admin consoles or logging modules. These consumers are integral parts of the management applications.

Generally, resources send all events they can provide to the existing management applications. Each change in one Service Date Element is reported, no matter if it is interesting with respect to user-defined rules. This results in enormous traffic between resources and management applications. Events are reported using SNMP (Simple Network Management Protocol). Consumers of higher-level events are usually part of the respective management applications. It is not possible to register external consumers. Furthermore, filtering and aggregation rules can only be defined within the respective management applications.

### OBJECT OF THE PRESENT INVENTION

Starting from this, an object of the present invention is to provide an Event Correlation System and method for monitoring resources that send low-level events which are filtered and aggregated in accordance with event filtering and aggregation rules to detect high-level events, avoiding the disadvantages of the prior art.

### BRIEF SUMMERY OF THE INVENTION

The present invention provides a new Event Correlation System and method for monitoring resources that send low-level events which are filtered and aggregated in accordance with event filtering and aggregation rules to detect high-level events.

For this solution as disclosed in the present invention, the following terms are used:
Service Data a set of attributes (name-value pairs) that define a system's state;
Service Data Element a single attribute (name-value pair) out of a system's Service Data;
Event an undirected message that informs about a change in a system's state, i.e. a change of one of the system's Service Data Elements;
Low-level Event a primitive event sent by a resource, usually carrying very little, primitive information (e.g. information about a change of a single Service Data Element);
Composite high-level Event a higher-level event that has been detected among low-level events using filtering rules; can contain information about the change of a combination of several Service Data Elements;
Aggregate high-level Event/Event Pattern a high-level event that has been detected as a result of aggregating several composite events, e.g. aggregation of multiple reoccurrences of a special type of composite event within a certain time frame (event pattern);
Filtering Rules rules that describe how composite events can be detected from low-level events;
Aggregation Rules rules that describe how composite events shall be aggregated to form aggregate events;
Standard Web Service Standard Web Services are software objects running on an application server and providing a service to a client; when a client calls a Standard Web Service, a new instance of this Web Service is instantiated; after finishing the call, the new instance is deleted;
Stateful Web Service with Stateful Web Services, new instances are not deleted after finishing a call; instances of Stateful Web Services may be addressed explicitly by a client; the client has access to information about the state of a called service; a service instance's state persists between different calls issued by clients.

The new Event Correlation System is characterized in that resources are monitored by a General Event Service Application that can be used by any client application to perform event filtering and aggregation.

A preferred embodiment of the Event Correlation System is characterized in that resources are implemented as Stateful Web Services and in that event filtering and aggregation is performed in Stateful Web Service environments.

The new Event Correlation System provides the advantage that no unsolicited event reporting takes place. Thus, the traffic between resources and management applications, i.e. the General Event Service Application, can be reduced. The implementation of the General Event Service as a Stateful Web Service makes it possible to register external consumers. The new Event Correlation System provides interfaces (i.e. Web Service Port Types) that allow for deploying externally defined rules during runtime. It is possible for a consumer to subscribe for receiving only special higher-level events. No additional filtering within the consumer has to be performed.

The General Event Service Application acts as a notification sink with respect to monitored resources. External clients, e.g.

Event Monitoring Applications or Network Administration Applications, can deploy filtering and aggregation rules into the General Event Service Application and subscribe for receiving notifications when higher-level events are detected. The General Event Service Application acts as a notification source with respect to mentioned clients.

A further preferred embodiment of the Event Correlation System is characterized in that the General Event Service Application comprises a Rules Base in which the event filtering and aggregation rules are stored. The event filtering and aggregation rules can be defined within a client application. These rules describe higher-level events this particular client is interested in.

A further preferred embodiment of the Event Correlation System is characterized in that the General Event Service Application comprises a Deployment Engine that inserts the event filtering and aggregation rules defined by clients into the Rules Base. The defined event filtering and aggregation rules can be deployed into the General Event Service Application using a common description language.

A further preferred embodiment of the Event Correlation System is characterized in that the General Event Service Application comprises a Resource Registration Engine that is triggered by the Deployment Engine to create necessary subscriptions with registered resources. The client can register a number of resources that shall be monitored by the General Event Service Application. Resources are registered with the Resource Registration Engine in the form of Stateful Web Service Handles.

A further preferred embodiment of the Event Correlation System is characterized in that the Resource Registration Engine cooperates with the Rules Base. The Resource Registration Engine analyzes rules contained in the Rules Base to see if any subscriptions have to be created with the registered resources, i.e. if rules exist that include low-level events provided by these resources. The General Event Service Application is able to query which low-level events or Service Data Elements are provided by a resource by using Stateful Web Service Introspection. If a resource provides Service Data Elements that are used in filtering or aggregation rules, the General Event Service Application creates subscriptions in order to be notified whenever these Service Data Elements change. Service Data Elements that are not of interest with respect to deployed rules will not be sent to the General Event Service Application in an unsolicited way since no subscriptions are created for such Service Data Elements. As a result, a considerable reduction of the traffic between resources and the General Event Service Application can be achieved.

It is preferred, that the General Event Service Application is a stand-alone application hosted by an Event Server.

The present invention relates further to a Stateful Web Service using the new Event Correlation Service System.

The new method for monitoring resources that send low-level events to an application that can perform event filtering and event aggregation in accordance with event filtering and aggregation rules to detect higher-level events, is characterized in that
a) the resources are implemented as Stateful Web Services,
b) the resources are monitored by a General Event Service Application that can be used by any client application to perform event filtering and aggregation in Stateful Web Service environments,
c) the General Event Service Application acts as a notification sink with respect to monitored resources, wherein the client can deploy filtering and aggregation rules into the General Event Service Application and subscribe for receiving notification when high-level events are detected,
e) the General Event Service Application acts as a notification source with respect to the mentioned clients.

A preferred embodiment of the monitoring method is characterized in that the client will be notified, whenever a high-level event it has subscribed for is detected, wherein high-level events that a client is not subscribed for will not be reported to that client. Hence, no additional filtering within the client is necessary.

The present invention relates further to a computer program product stored in the internal memory of a digital computer, containing parts of software code to execute the above described method.

### BRIEF DESCRIPTION OF THE DRAWINGS

The above, as well as additional objectives, features and advantages of the present invention will be apparent in the following detailed written description.

The novel features of the present invention are set forth in the appended claims. The invention itself, however, as well as a preferred mode of use, further objectives, and advantages thereof, will be best understood by reference to the following detailed description of an illustrative embodiment when read in conjunction with the accompanying drawings, wherein:

FIG. 1 shows a prior art Event Correlation System;

FIG. 2 shows an Event Correlation System according to the present invention;

FIG. 3 shows a flow chart about the handling of rules for event filtering and aggregation in accordance with the present invention;

FIG. 4 shows a flow chart about the use of subscriptions in accordance with the present invention and

FIG. 5 shows an application scenario according to the present invention.

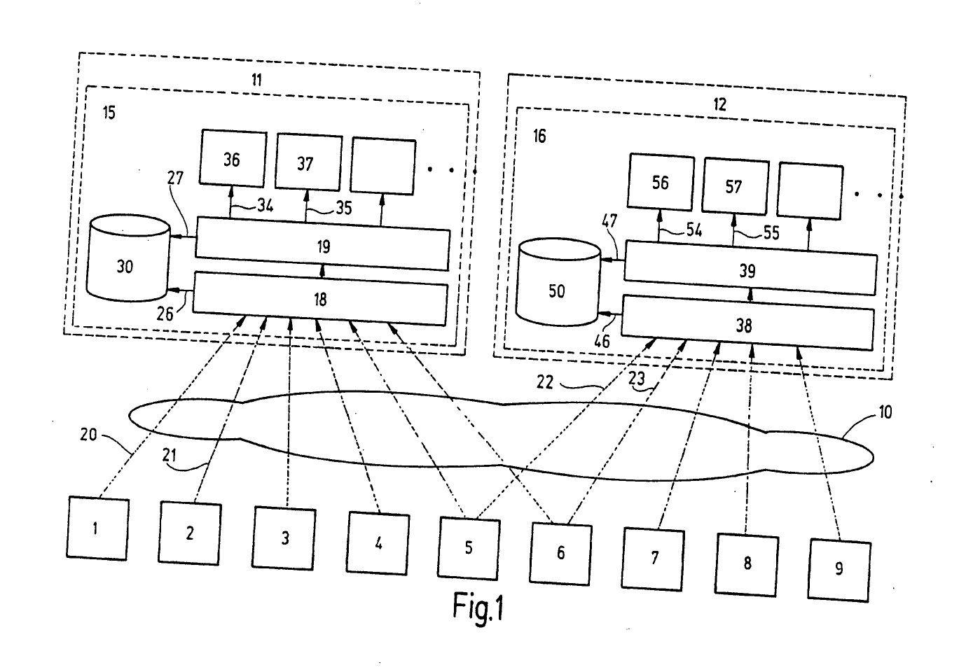

FIG. 1 shows a number of distributed resources 1-9 sending low-level events using protocols such as SNMP (Simple Network Management Protocol). These low-level events carry information about the change of single Service Data Elements of the resources (e.g. CPU-utilization of a resource changed). By a network 10, resources 1 to 9 communicate with Management Servers 11, 12. Management Servers 11, 12 comprise Management Applications 15, 16 that can perform Event Detection and Filtering 18, 38 and Event Aggregation and Pattern Detection 19, 39. Event Detection and Filtering 18, 38 and Event Aggregation and Pattern Detection 19, 39 are based on the low-level events to create more valuable higher-level events. Sending of low-level events from resources 1 to 9 to Management Servers 11, 12 is indicated by Arrows 20, 21 and 20, 23. Users of Management Applications 15, 16 can, as indicated by Arrows 26,27; 46,47; define filtering and aggregation rules which describe those high-level events they are interested in. For example it is possible to describe a composite event “E” that shall exist, if a resource's CPU-utilization is above 90% AND its free working memory is below 5%. Furthermore, users can define aggregate events or event patterns based on previously defined composite events. For instance it is possible to define a pattern “P” that shall be detected if the composite event “E” occurred more than 10 times within a minute.

All user-defined rules are stored in a Rules Base 30; 50. If primitive events sent by resources 1 to 9 are received, as indicated by Arrows 20, 21 and 22, 23, the Event Detection and Filtering Component 18, 38 analyzes all filtering rules contained in the Rules Base 30; 50 and tries to detect composite events. Subsequently, the Event Aggregation and Pattern Detection Component 19, 39 uses the user-defined rules to aggregate recognized composite events and to detect aggregate events/event pattern. All detected higher-level events (composite events as well as aggregate events/event patterns) are, as indicated by Arrows 34,35; 54,55, reported to several consumers 36,37; 56,57, such as event monitors, admin consoles or logging modules. These consumers 36,37; 56,57 are integral parts of Management Applications 15, 16.

Generally, resources 1 to 9 send all events they can provide to existing Management Applications 15, 16. Each change in one Service Data Element is reported, no matter if it is interesting with respect to the defined rules, i.e. an unsolicited event reporting takes place. This results in enormous traffic between resources 1 to 9 and Management Applications 15; 16. Consumers 36,37; 56,57 are parts of the respective Management Applications 15; 16. It is not possible to register external consumers. Furthermore, filtering and aggregation rules can only be defined within the respective Management Applications 15; 16. No interfaces (e.g. Web Service Ports) exist, that allow for deploying externally defined rules during runtime. Consumers 36,37; 56,57 of higher-level events receive all high-level events that are defined within a management application's Rules Base 30; 50. However, if a consumer is interested only in some of the high-level events, additional filtering has to be performed. It is not possible for a consumer to subscribe for receiving only special high-level events.

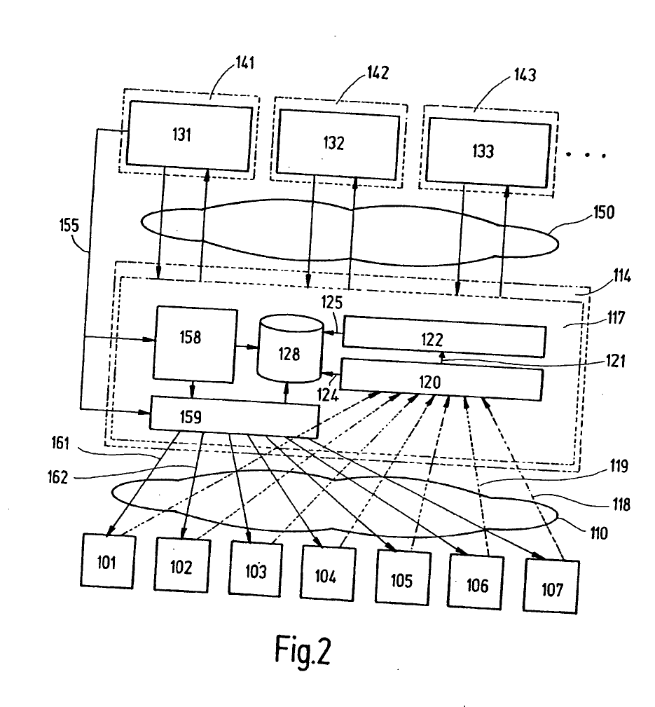

FIG. 2 shows an Event Correlation System according to the present invention. Resources 101 to 107 communicate by a network 110 with an Event Server 114. Event Server 114 comprises a General Event Service Application 117. As indicated by Arrows 118, 119, resources 101 to 107 send low-level events to an Event Detecting and Filtering Component 120 of Event Server 114. Event Detecting and Filtering Component 120 communicates, as indicated by an Arrow 121, with an Event Aggregation and Pattern Detection Component 122. As indicated by Arrows 124 and 125, Event Detection and Filtering Component 120 and Event Aggregation and Pattern Detection Component 122 communicate with a Rules Base 128 where Event Filtering and Aggregation Rules are stored.

General Event Service Application 117 can be used by any client application 131, 132, 133 to perform event filtering and aggregation in Stateful Web Services environments. Client applications 131-133, such as event monitoring applications, network administration applications or on-demand Gaming Applications, are hosted by Servers 141-143. Servers 141-143 communicate with Event Server 114 over network 150 that can be the same network as 110. General Event Service Application 117 acts as a notification sink with respect to monitored resources 101-107. External clients 131-133 can deploy filtering and aggregate rules into the General Service Application 117 and subscribe for receiving notification when higher-level events are detected. General Event Service Application 117 acts as a notifications source with respect to the mentioned clients 131-133.

As indicated by an Arrow 155, client applications 131-133 communicate with a Deployment Engine 158 and with a Resource Registration Engine 159. Event filtering and aggregation rules can be defined within client applications 131-133. These rules describe the high-level events this particular client is interested in. The defined rules can be deployed into the General Event Service Application 117 using a common description language. Deployment Engine 158 inserts the new rules into Rules Base 128 and triggers Resource Registration Engine 159 to create necessary subscriptions with registered resources 101-107, as indicated by Arrows 161, 162.

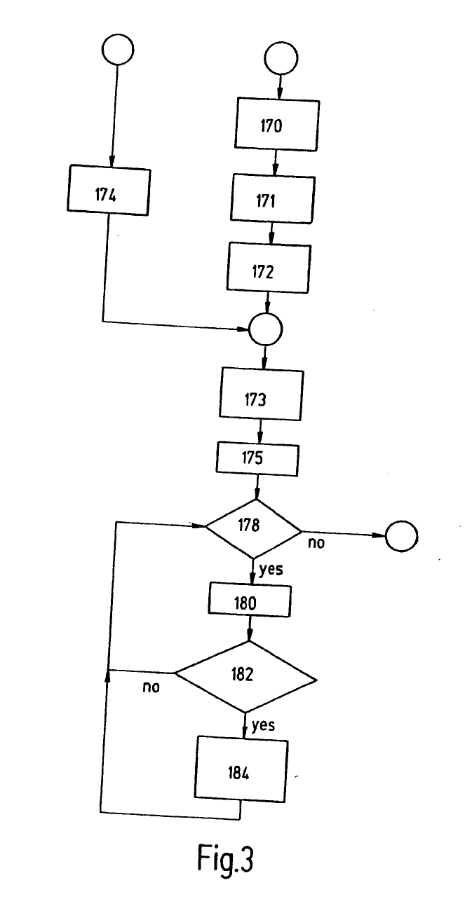

FIG. 3 shows a first flow chart illustrating the operation of the Event Correlation System shown in FIG. 2. In operation block 170, rules for event filtering and aggregation are defined. According to the present invention rules for event filtering and aggregation can be defined in a client application that is interested in higher-level events. These rules describe the higher-level events this particular client is interested in. In operation block 171 the defined rules are deployed into the General Event Service Application using a common description language. In operation block 172 the Deployment Engine deploys the defined rules into the Rules Base.

In operation block 173, the Resource Registration Engine is triggered to create necessary subscriptions with registered resources. In operation block 174, the client or the client application can register a number of resources that shall be monitored by the General Event Service Application. Resources are registered with the Resource Registration Engine in the form of Stateful Web Service Handles. In operation block 175, the Resource Registration Engine analyzes the Rules Base to see if any subscriptions have to be created with the newly registered resource or with previously registered resources, i.e. if rules exist that include Service Data Elements provided by a resource. The General Event Service Application is able to query which Service Data Elements are provided by a resource by using Stateful Web Service Introspection. In branch 178, it is checked whether there is another resource to check.

In operation block 180, the further resource is introspected. In branch 182, it is checked whether the resource provides Service Data Elements corresponding to deployed rules. If yes, in operation block 184, subscriptions are created for those Service Data Elements that are mentioned in rules. If a resource provides Service Data Elements that are used in filtering or aggregation rules, the General Event Service Application creates subscriptions in order to be notified whenever these Service Data Elements change. Service Data Elements that are not of interest with respect to deployed rules will not be sent to the General Event Service Application in an unsolicited way since no subscriptions are created for such Service Data Elements. As a result, a considerable reduction of the traffic between resources and the General Event Service Application can be achieved.

Example: A resource that provides three Service Data Elements (CPU-utilization, free memory, CPU-temperature) is registered with the General Event Service Application. A rule “R” exists that describes a composite event “E” that shall exist, if a resource's CPU-utilization is above 90% AND its free memory is below 5%. Subscriptions for the CPU-utilization and the free memory Service Data Elements will be created by the General Event Service Application since both Service Data Elements are mentioned in rule “R”.

The client application that is interested in being notified whenever defined higher-level events are detected can now subscribe with the General Event Service Application. Subsequently, the client will be notified, whenever a higher-level event it has subscribed for is detected. Higher-level events that a client is not subscribed for will not be reported to that client. Hence, no additional filtering within the client application is necessary.

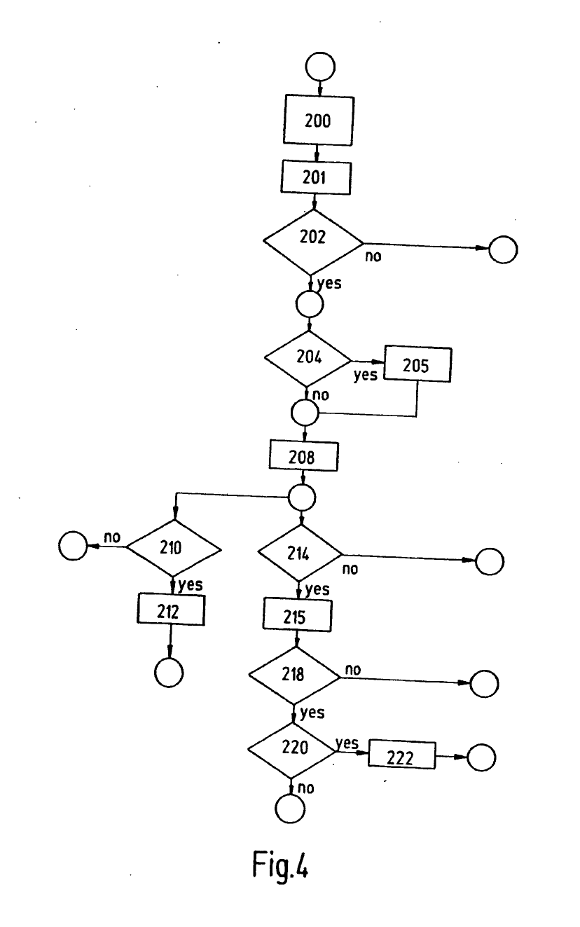

FIG. 4 shows a flow chart referring to detection, filtering, aggregation and pattern detection. In operation block 200, Service Data Elements that the General Event Service Application has subscribed for are sent from monitored resources to the General Event Service Application. In operation block 201, the General Event Service Application checks the low-level events against the Rules Base. In branch 202, it is checked whether the low-level events correspond to events defined by rules. If yes, it is checked in branch 204 whether there are clients who are subscribed for that event. If yes, in operation block 205, these subscribed clients are notified. If no, in operation block 208, pattern detection on the event is performed. In branch 210, it is checked whether the event can activate a pattern. If yes, in operation block 212, the corresponding pattern is activated. In branch 214, it is checked whether the event fits into any active pattern. If yes, in operation block 215, the event is added to pattern. In branch 218, it is checked whether recognized patterns are completed. If yes, in branch 220, it is checked whether there are clients who are subscribed for this pattern. If yes, in operation block 222, the subscribed clients are notified. The General Event Service Application uses deployed filtering and aggregation rules to perform event filtering and aggregation on received low-level events. Whenever high-level events are detected, client that have subscribed for these events are notified.

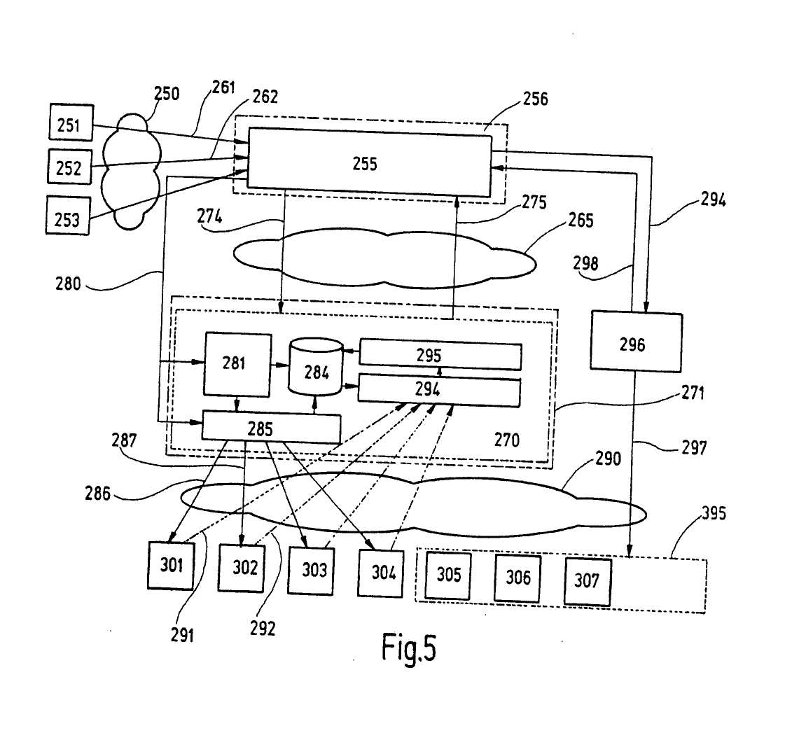

FIG. 5 shows an application scenario for the Event Correlation System according to the present invention. Over the Internet 250 players 251-253 can connect to an on-demand Gaming Application 255 and meet in virtual game worlds, as indicated by Arrows 261, 262. Gaming Application 255 uses several distributed resources 301-307, the number of which varies depending on the load (i.e. the number of players) put on the system. Using rules and workflows Gaming Application 255 can adapt to the current load automatically. To do this, resources 301-307 must be constantly monitored.

Gaming Application 255 communicates over a Network 265 with a General Event Service Application 270. Gaming Application 255 is hosted by a Server 256. General Event Service Application 270 is hosted by a separate Event Server 271. As indicated by an Arrow 274, high-level subscriptions can be transmitted from Gaming Application 255 to General Event Service Application 270. As indicated by an Arrow 275 high-level events are transmitted from General Event Service Application 270 to Gaming Application 255.

Event filtering and aggregation rules can be defined within Gaming Application 255. These rules describe the higher-level events Gaming Application 255 is interested in. As indicated by an Arrow 280, defined rules can be deployed into General Event Service Application 270. A Deployment Engine 281 that is integrated in General Event Service Application 270 inserts new rules into a Rules Base 284 and triggers a Resource Registration Engine 285 to create necessary subscriptions with registered resources, as indicated by Arrows 286, 287. As indicated by arrows 286, 287 resources 301-307 communicate with General Event Service Application 270 over a Network 290. As indicated by Arrows 291, 292, Service Data Elements that General Event Service Application 270 has subscribed for are sent from monitored resources to an event detection and filtering component 294 that communicates with Rules Base 284 and an event aggregation and pattern detection component 295.

Event filtering and aggregation rules define a number of high-level events the on-demand Gaming Application 255 has to react on (e.g. overload on used servers). These event filtering and aggregation rules are deployed into the General Event Service Application 270 and resources 301-304 used by the Gaming Application 255 are registered with the General Event Service Application 270. Whenever defined high-level events are detected by the General Event Service Application 207, the on-demand Gaming Application 255 is notified. If, for example, a high-level event indicates that an overload on all of the Gaming Application's Servers 301-304 existed for more than 5 minutes, the Gaming Application 255 has to increase capacity in order to adapt to the current load.

As indicated by Arrow 294, Gaming Application 255 requests new resources 305, 306, 307 from a Resource Manager 296. Resource Manager 296 which has control over a free pool of resources 305-307 assigns free resources 305-307 to Gaming Application 255, as indicated by Arrow 297, and passes handles to these resources to Gaming Application 255, as indicated by Arrow 298. Gaming Application 255 then passes the resource handles to the General Event Service Application 270, as indicated by Arrow 280, and, thus registers new resources 305-307 to be monitored by the General Event Service Application 270. Resource registration engine 285 queries Rules Base 284 to check if subscriptions have to be created with new resources 305-307. If subscriptions have to be created with the newly registered resources, the Resource Registration Engine creates these subscriptions. Subsequently, General Service Application 270 will receive the required low-level events on which event filtering and aggregation can be performed.

1. Apparatus for monitoring resources that send low-level events comprising:
means for filtering and aggregating events in accordance with event filtering and aggregation rules to detect high-level events; and
a general event service application for monitoring resources that can be used by a client application to perform event filtering and aggregation.

2. Apparatus in accordance with claim 1, further comprising means for event filtering and aggregation of events from resources that are implemented as stateful web services.

3. Apparatus in accordance with claim 1, wherein the general event service application comprises a rules base in which the event filtering and aggregation rules are stored.

4. Apparatus in accordance with claim 3, wherein the general event service application further comprises a deployment engine that inserts the event filtering and aggregation rules into the rules base.

5. Apparatus in accordance with claim 4, wherein the general event service application further comprises a resource registration engine that is triggered by the deployment engine to create necessary subscriptions with registered resources.

6. Apparatus in accordance with claim 5, wherein the resource registration engine cooperates with the rules base.

7. Apparatus in accordance with claim 1, wherein the general event service application is a stand-alone application hosted by an event server.

8. Method for monitoring resources that send low-level events to an application that can perform event filtering and event aggregation in accordance with event filtering and aggregation rules to detect higher-level events, comprising:
a) implementing resources as stateful web services;
b) monitoring the resources by a general event service application that can be used by a client application to perform event filtering and aggregation in stateful web service environments;
c) the general event service application acting as a notification sink with respect to the monitored resources;
d) the client application deploying filtering and aggregation rules into the general event service application and subscribing for receiving notification when higher-level events are detected;
d) the general event service application acting as a notification source with respect to said client application.

9. Method in accordance with claim 8, further comprising:
notifying the client application whenever a high-level event it has subscribed for is detected and not notifying the client application whenever a high-level event it has not subscribed for is detected.

10. Computer program product stored in the internal memory of a digital computer, containing software code to execute the method of claim 8.

11. Computer program product stored in the internal memory of a digital computer, containing software code to execute the method of claim 9.
